(19) United States
(12) Patent Application Publication
(10) Pub. No.: US 2005/0223223 A1
(43) Pub. Date: Oct. 6, 2005

(54) Authentication apparatus and authentication method

(75) Inventor: Tsuyoshi Hirose, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/094,517

(22) Filed: Mar. 31, 2005

(30) Foreign Application Priority Data
Apr. 1, 2004 (JP) 2004-108934

(51) Int. Cl. H04L 9/00

(52) U.S. Cl. 713/165; 726/2

(57) ABSTRACT

In order to solve concerns about processes performed on a display screen for an authentication program which limits access to each file, the authentication program has an authentication process to request authentication of each file at the time of using the files. The authentication process controls a computer to execute operations of analyzing the authentication character-string input for the file name, determining whether the result of analysis is right or wrong, and opening and closing the file to enable use of the file when the result of analysis is right and to disable use of the file when the analysis result is wrong.

### CROSS-REFERENCE TO RELATED APPLICATION

This application is related to and claims priority to Japanese Application No. 2004-108934 filed Apr. 1, 2004 in the Japanese Patent Office, the contents of which are hereby incorporated by reference.

### BACKGROUND OF THE INVENTION

1. Field of the Invention

The present invention relates to user authentication for authenticating use of files.

2. Description of the Related Art

Recently, image files or the like being used throughout the Internet are sometimes illegally copied by a third party. Therefore, certain solutions are provided for performing authentication prior to use of image files or the like, by a server for management of image files or the like.

However, if such an authentication procedure malfunctions, all files in the server may become available for use. Therefore, in order to further enhance security, a means for providing authentication is used for utilizing image files or the like.

Application of authentication to each image file as done in the prior art, causes a problem in that an authentication system must be configured in each server for management of image files.

The following prior art has been proposed as an authentication means for performing authentication to access each file. Japanese Patent Application Laid-Open No. Hei 11 (1999)-65938 discloses a mobile electronic apparatus. A plurality of key data (passwords) is stored within a data memory, these key data are collated selectively with externally input key data, and the result of collation is stored for each key data. At the time of access to the data memory area, the access can be realized when any one of the collation results stored is affirmative, or when all results of collation being stored are affirmative. Moreover, these can be set for each instruction data for access to each area of the data memory. This prior art sets the limitation of access to each file for each mobile electronic apparatus.

However, the above patent document discloses display of dialog images for inputting the authentication information, which results in a problem that the dialog image or the like is displayed each time the authentication is made.

### SUMMARY OF THE INVENTION

An aspect of the present invention is to provide a solution for removing the burden of displaying dialog images during the authentication process for each file.

To achieve the above aspect, the present invention includes a computer-readable medium storing a program which, when executed by a computer, causes the computer to perform operations for authenticating use of each file, comprising analyzing a file name input by a user, determining whether a result of said analyzing is right or wrong, and enabling use of the file when it is determined that the result of the analysis is right and disabling use of the file when it is determined that the analysis result is wrong.

Moreover, the present invention includes an authentication apparatus to authenticate use of each of a plurality of files, comprising a storage unit storing files, an input unit inputting a file name of one of the files read from the storage unit, and an authentication processing unit conducting authentication for use of the one of the files by analyzing whether the inputted file name is right or wrong.

Moreover, the present invention includes an authentication method for authenticating use of each of a plurality of files comprising analyzing a file name input by a user, determining whether a result of the analysis is right or wrong, and enabling use of the file when it is determined that the analysis result is right or disabling use of the file when it is determined that the analysis result is wrong.

The present invention is capable of remarkably controlling illegal copying of image files even when the image file authentication is not validated for each server used for management of image files, because a program for file authentication is distributed directly or transmitted in the form that the program is included within the image file. Moreover, the present invention is also cable of eliminating concerns about the display of dialog images or the like, because authentication is validated by changing the file name.

### BRIEF DESCRIPTION OF THE DRAWINGS

FIG. 1 is a diagram illustrating a file distributing/authenticating system in accordance with an embodiment of the present invention.

FIG. 2 is a block diagram of a server 1 of a service provider and an information electronic apparatus 2 in accordance with an embodiment of the present invention.

FIG. 3 is a flowchart illustrating the operation for determining the user authentication file name in the information electronic apparatus 2.

FIG. 4 is a flowchart illustrating the image file authentication operation with the user authentication software transmitted and distributed from the server 1.

FIG. 5 is a flowchart illustrating the operation of the information electronic apparatus 2 especially for a file which has already completed the user authentication.

FIG. 6 is a flowchart of the operation of the information electronic apparatus 2 for authenticating a self-extract image file by using the authentication function.

### DETAILED DESCRIPTION OF THE PREFERRED EMBODIMENTS

The present invention is described in detail below with reference to the drawings wherein like numerals refer to like parts throughout.

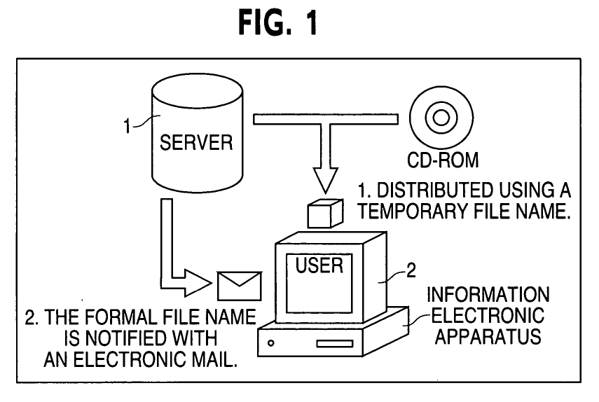

FIG. 1 is a structural diagram illustrating a preferred embodiment of the present invention. A server 1 of a service provider transmits image files to an information electronic apparatus 2 (e.g., a PC) of a user who is provided with a file distributing service. An image file is used as a practical example of a file to be distributed in this embodiment. In accordance with a request for an image file issued from a user, the server 1 transmits the predetermined image file to the information electronic apparatus 2 over a network such as the Internet. Moreover, it is also possible to distribute the desired image file to a user by distributing, to the user, a storage medium such as a CD-ROM (Compact Disk-Read Only Memory) storing image files from the server. In this case, the image file is transmitted and distributed under the condition that it is given a temporary file name.

The server 1 also transmits authentication software to execute authentication by reading image files through the network, or distributes such software using a CD-ROM. The image file having the temporary file name can be read or used by performing authentication using the authentication software which is transmitted from the server or distributed on CD-ROM. The authentication is a process to change the temporary file name in an image file name column to a user authentication file name.

If the authentication software is not installed in the information electronic apparatus 2 of a user, when a user executes a process to open a file having a temporary file name, the information electronic apparatus 2 cannot read and use the image file having the temporary file name. Moreover, even when the authentication software is installed on the information electronic apparatus 2 of a user, the file cannot be read and used if the temporary file name has not been altered or modified to the correct user authentication file name.

Moreover, a file of the authentication software can also be transmitted or distributed as a self-extract program through the combination of a read function and an authentication function transmitted with the image file. In this case, the temporary file name of the image file is read with the self-extract program provided for the image file. A user can read and use the image file by changing the temporary file name of the image file obtained, to a user authentication file name.

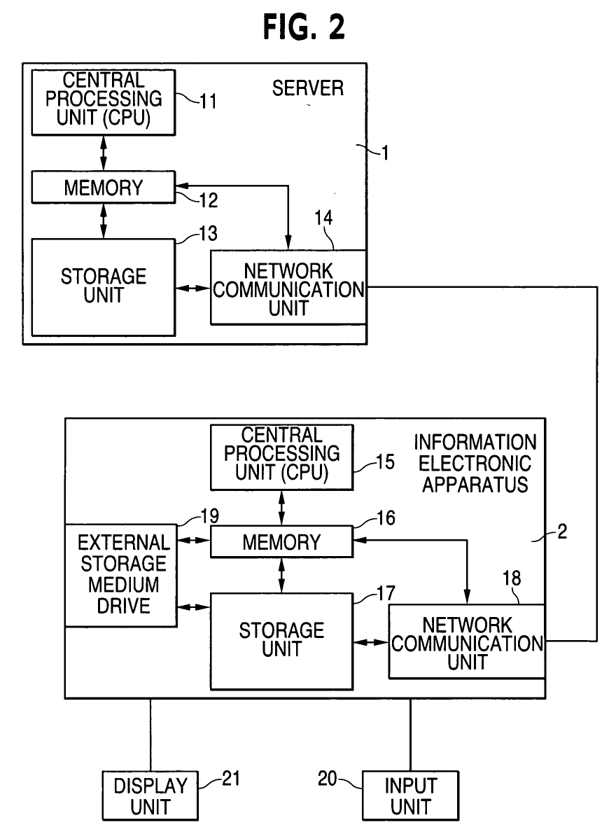

FIG. 2 is a block diagram of the server 1 of the service provider, which transmits the image file, and an information electronic apparatus 2 with which a user can read and use the image file. The server 1 is provided with a central processing unit (CPU) 11, a memory 12, a storage unit 13, and a network communication unit 14. The information electronic apparatus 2 is provided with a central processing unit (CPU) 15, a memory 16, a storage unit 17, a network communication unit 18, and an external storage medium drive 19. The information electric apparatus 2 is connected to an input unit 20 and a display unit 21.

The server 1 receives an image file request signal from a user via the network communication unit 14. The central processing unit 11 issues, to the storage unit 13, an instruction to transmit the stored image file having a temporary name, from the network communication unit 14. In this case, the central processing unit 11 notifies the information electronic apparatus 2 of a bill for the image file application fee, via the network communication unit 14. Moreover, the server 1 also transmits authentication software stored in the storage unit 13 through the network communication unit 14.

The information electronic device 2 receives the image file and user authentication software through the network communication unit 18. A user installs the user authentication software on the information electronic apparatus 2. The installed user authentication software is stored in the storage unit 17. The received image file is also stored in the storage unit 17.

Moreover, a user transmits the application fee payment information for the image file via the network communication unit 18. The server 1 stores, for management purposes, the user's application fee payment information in the storage unit 13. When the user's application fee payment information indicating that the payment has been executed, is stored in the storage unit 13, the central processing unit 11 transmits a user authentication file name to the information electronic apparatus 2 via electronic mail or the like. The user alters the temporary file name of the image file to the user authentication file name via the input unit 20. The authentication software is stored in the memory 16 with the image file opening signal.

The central processing unit 15 acts as an authentication processing unit which reads the user authentication file name input from the input unit 20 using the user authentication software, and determines whether the user authentication file name is the correct user authentication file name or not. When the user authentication file name is correct, the central processing unit 15 defines the image file as the file to be used and read in accordance with the authentication file software. The central processing unit 15 again alters the file name of the image file to the temporary file name, and records the image file after it has once completed the authentication process, as an authenticated file in an information file incorporated in the authentication software stored in the storage unit 17. Moreover, if the central processing unit 15 has determined that the user authentication file name inputted via the input unit 20, is wrong, the central processing unit 15 displays a warning dialog “A user authentication file name is wrong” on the dialog display unit 21, indicating that a user authentication file name is wrong.

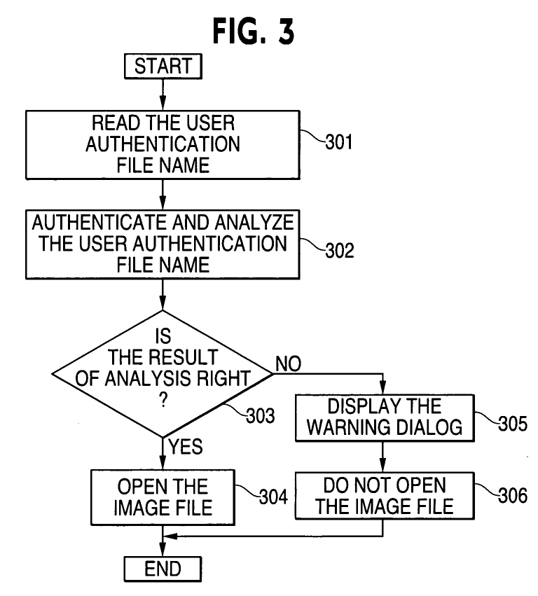

FIG. 3 is a flowchart illustrating the operation of determining the user authentication file name in the information electronic apparatus 2. The information electronic apparatus 2 drives the user authentication software. The information electronic apparatus 2 reads the user authentication file name of the image file (operation 301). The user authentication file name obtained is analyzed for authentication on the basis of the user authentication file name authentication rule of the user authentication file name authentication software (operation 302). The result of analysis of the user authentication file name is determined to be right (correct) or wrong (operation 303). When the analysis result of the user authentication file name obtained is right, the image file is opened (operation 304). When the analysis result is wrong a warning dialog is displayed (operation 35) and the image file is not opened (operation 306).

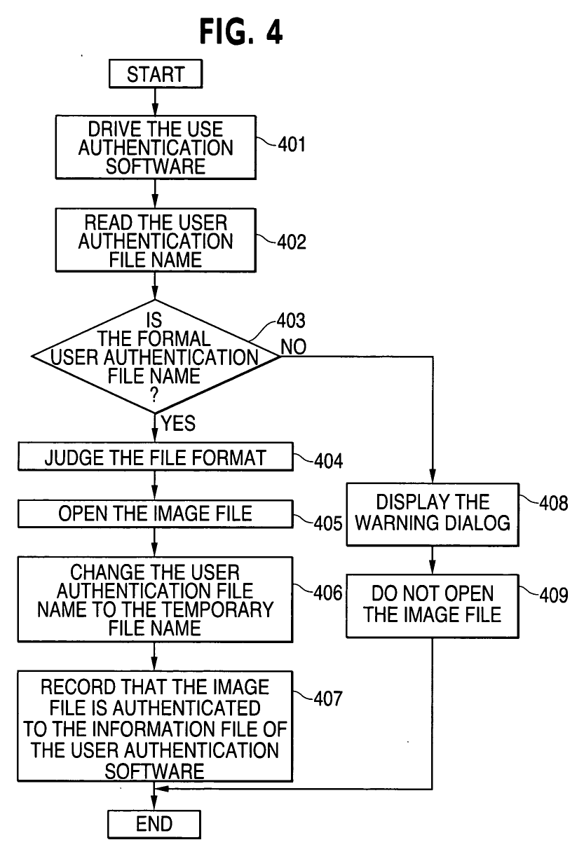

FIG. 4 is a flowchart illustrating the image file authentication operation with the user authentication software transmitted and distributed from the server 1. First, a user sends a request for the desired image file to the server 1 via the network. The server 1 distributes, in response to the request from a user, the image file using the temporary file name at the time of transmission or distribution of the image file via the Internet or transmission of an electronic mail, or distribution via a CD-ROM.

A user obtains the user authentication software transmitted or distributed from the server 1 and then installs this software on the information electronic apparatus 2 of the user. The server 1 sends an application fee bill for the image file to the user via the network. The server 1 notifies, to the user who has paid the application fee, the user authentication file name for user authentication using an electronic mail message.

The user changes the temporary file name of the distributed image file to the user authentication file name notified from the server 1. The user sends an instruction to open the image file in which the file name has been changed to the user authentication file name. The information electronic apparatus 2 drives the installed authentication software with the image file opening signal (operation 401). The user authentication software reads the user authentication file name (operation 402). It is determined whether the user authentication file name is the right or formal user authentication file name or not (operation 403). When the user authentication file name is right, the image file is opened after judging a file format (operations 404, 405). The user authentication file name of the image file is changed again to the temporary file name using the user authentication software (operation 406). Accordingly, since the image file is not maintained under the usable condition, illegal use of the image file by a third party can be prevented. The user authentication software records the end of authentication to the information file distributed with the authentication software (operation 407).

When the user authentication file name is wrong (operation 403), a warning dialog indicating that the user authentication file name is wrong is displayed, and the image file is not opened (operations 408, 409).

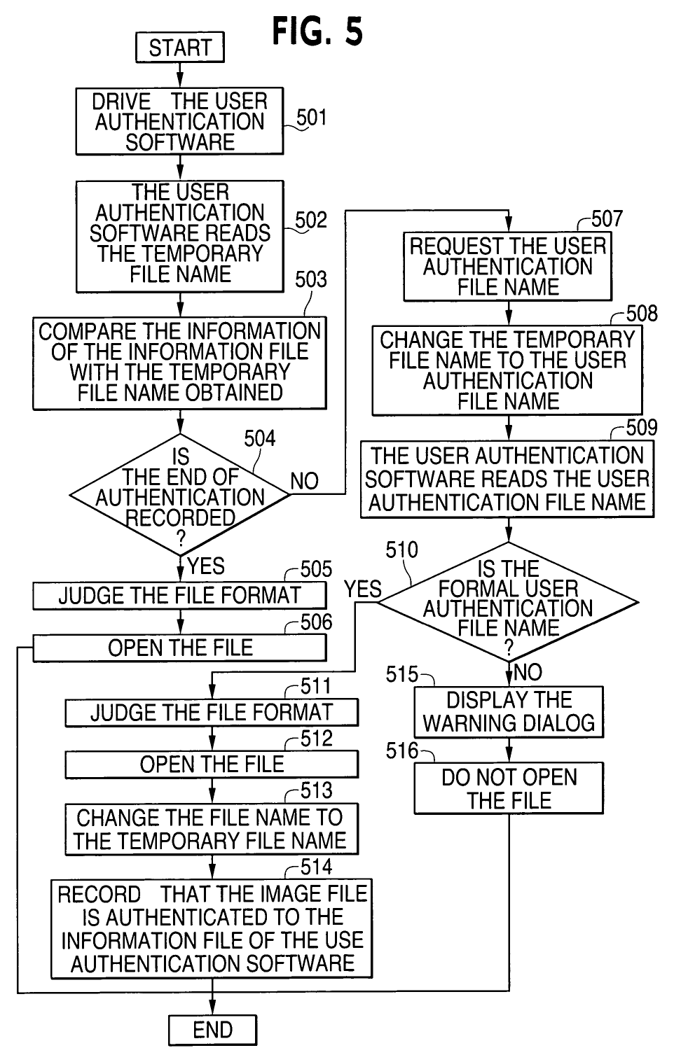

FIG. 5 is a flowchart illustrating repeated use and accessing of the image file which has already completed the user authentication process. A user issues an instruction to again open an image file which has already completed the authentication process. The user authentication software is driven with the image file opening signal (operation 501). The user authentication software reads the temporary file name and determines, through comparison with the recorded information file, whether the temporary file name obtained has been recorded in the information file as an authenticated file name or not (operations 502, 503, 504). For example, such recorded authentication occurs at operation 407 of FIG. 4. When the temporary file name has been recorded in the information file as an authenticated file name, the image file is opened after judging a file format (operations 505, 506). When the temporary file name has not been recorded in the information file as an authenticated file name, a user requests a user authentication file name (operation 507). A user changes the temporary file name to the user authentication file name (operation 508). The user authentication file name is read using the user authentication software (operation 509). It is determined whether the user authentication file name obtained is the right (formal) user authentication file name or not (operation 510).

When the user authentication file name is right (correct), the file format is judged and the image file software is driven to open, use and read the image file (operations 511, 512). The file name of the image file is changed again to the temporary file name with the user authentication software (operation 513). The user authentication software records that authentication of the image file has been completed to the information file of the authentication software (operation 514). Thus, an image file can be used and read even when a user does not execute the process to update the temporary file name to open again the image file by storing, to the information file, the information indicating that the image file has completed the user authentication. If the user authentication file name is wrong, the warning dialog indicating that the user authentication file name is wrong, is displayed, and the image file is not opened (operations 515, 516).

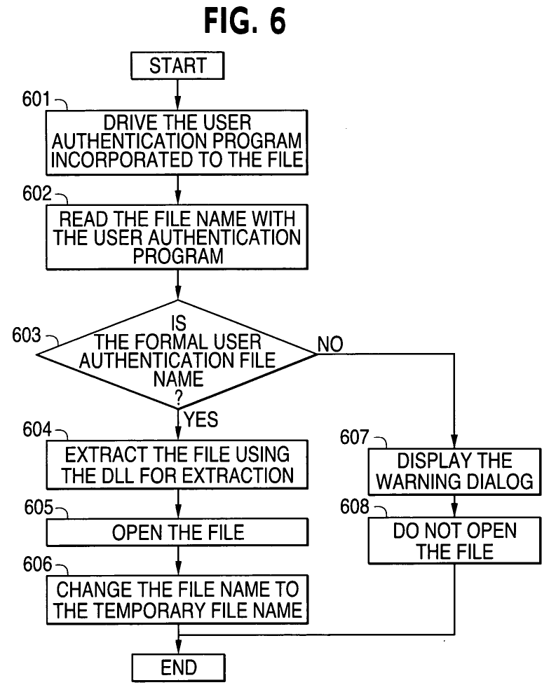

FIG. 6 is a flowchart illustrating an operation of authenticating a self-extract image file which combines the image file with the authentication function. Here, the self-extract image file refers to a compressed file for executing an incorporated user authentication program with self-execution. Thus, the procedure required for the user to install the user authentication software can be eliminated. A user sends a request to the server 1 for the desired self-extract image file via the network. The server 1 transmits or distributes, in response to the request from the user, the self-extract image file via the Internet, via transmission of an electronic mail message or via distribution of a CD-ROM. The server 1 sends an application fee bill for the image file to the user via the network. The server 1 also notifies the user who has paid the application fee, of the user authentication file name for user authentication via an electronic mail message.

The user changes the temporary file name of the distributed self-extract image file to the user authentication file name provided by the server 1. The user also sends an instruction to open the self-extract image file in which the file name has been changed to the user authentication file name. Here, the user authentication program is driven to read the user authentication file name and to determine whether the user authentication file name is right or not (operations 601, 602, 603). When the user authentication file name is right, the self-extract image file is extracted using DLL (Dynamic Link Library) and the image file is opened (operations 604, 605). After the extraction of the self-extract image file, the user authentication file name is changed again to the temporary file name (operation 606). When the file name is wrong (operation 603), the warning dialog box is displayed and the file is not opened (operations 607, 608). Moreover, it is also possible to distribute to the user in advance a self-extract program engine such as the DLL file to the user.

Next, examples of modifications of the embodiment of the authentication program of the present invention and other technical expansion examples will be described below.

An image file is described as an example file in the embodiment described above. However, the present invention is not limited thereto and the present invention can also be adapted to other file formats used by the information electronic apparatus 2, such as a video file, an audio file or the like.

In the above embodiment, authentication is required for image files to which the application fee is charged but the present invention is not directed to managing the payment of charges.

In the above embodiment, transmission of electronic mail and distribution of a CD-ROM have been described as possible approaches for transmitting and distributing the image files or the like, but the present invention is not limited thereto and other transmitting and distributing approaches may be used.

In the above embodiment, completion of authentication is recorded to the information file incorporated with the authentication file software, but the present invention is not limited thereto and recording thereof to other files may be performed.

In the above embodiment, if the user authentication file name is determined to be wrong, the dialog box “the user authentication file name is wrong” is displayed on the dialog unit, but the present invention is not limited thereto, and transmission of other visual notifications, may be used to suggest the user authentication file name is wrong.

In the above embodiment, the self-extract program engine is distributed previously as a DLL file, but the present invention is not limited thereto, and distribution may occur simultaneously with, or after, the self-extract file.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

1. A computer-readable medium storing a program which, when executed by a computer, causes the computer to perform operations for authenticating use of each file, comprising:
analyzing a file name input by a user;
determining whether a result of said analyzing is right or wrong; and
enabling use of the file when it is determined that the result is right and disabling use of the file when it is determined that the result is wrong.

2. A computer-readable medium according to claim 1, further comprising:
recording information which indicates completion of the authenticating when the result of analysis is right.

3. A computer readable medium according to claim 2, further comprising allowing subsequent access to the file based on the recorded information indicating completion of authenticating and without said determining.

4. A computer readable medium according to claim 1, wherein the file comprises an image file, a video file, an audio file or a text file.

5. An authentication apparatus to authenticate use of each of a plurality of files, comprising:
a storage unit storing files;
an input unit inputting a file name of one of the files read from said storage unit; and
an authentication processing unit conducting authentication for use of the one of the files by analyzing whether said inputted file name is right or wrong.

6. An authentication apparatus according to claim 5, wherein the stored files are image files, video files, audio files or text files.

7. An authentication apparatus according to claim 5, wherein said authentication processing unit records information which indicates completion of the authentication when the inputted file name is right.

8. An authentication apparatus according to claim 7, wherein said authentication processing unit allows further subsequent access to the file corresponding to said inputted file name based on the prior authentication.

9. An authentication method for authenticating use of each of a plurality of files, comprising:
analyzing a file name input by a user;
determining whether a result of said analyzing is right or wrong; and
enabling use of the file when it is determined that the result is right or disabling use of the file when it is determined that the result is wrong.

10. An authentication method according to claim 9, wherein the file is an image file, a video file, an audio file, or a text file.

11. An authentication method according to claim 9, further comprising recording information which indicates completion of the authenticating when the result of analyzing is right.

12. Authentication method according to claim 11, further comprising enabling subsequent use of the file based on the recorded information indicating completion of the authenticating.

13. A server distributing files, comprising:
a storage unit storing files; and
a processing unit to send a file designated by a temporary file name and to send an authenticated file name for the file in accordance with receiving a payment information for the file.

14. A server according to claim 13, wherein the files are image files, video files, audio files or text files.

15. A computer-readable medium storing a program which, when executed by a server, causes the server to perform operations, comprising:
sending a file designated by a temporary file name; and
sending an authenticated file name for the file in accordance with receiving a payment information for the file.

16. A computer readable medium according to claim 15, wherein the file is an image file, a video file, an audio file or a text file.

17. A system for authenticating use of each file, comprising:
a server that sends a file designated by a temporary file name;
a computer that stores the file, wherein the computer further comprises:
an input unit inputting a file name for the file; and
an authentication processing unit conducting authentication for use of the file by comparing the file name input by the input unit with the file name sent by the server.

18. A system according to claim 17, wherein the file is an image file, a video file, an audio file or a text file.
